(19) United States
(12) Patent Application Publication
(10) Pub. No.: US 2013/0152723 A1
(43) Pub. Date: Jun. 20, 2013

(54) ROBOT ARM

(71) Applicant: BO LONG, Shenzhen City (CN)

(72) Inventor: BO LONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/472,665

(22) Filed: May 16, 2012

(30) Foreign Application Priority Data
Dec. 17, 2011 (CN) 201110423697.X

(51) Int. Cl. B25J 17/02; B25J 18/00

(52) U.S. Cl. 74/490.03; 74/490.06; 901/23; 901/29

(57) ABSTRACT

A robot arm includes a wrist body, an arm body, a first shaft, a first driving mechanism, a second shaft and a second driving mechanism. The arm body includes an installation wall and a mounting cylinder connecting with an installation portion of the installation wall. One end of the installation wall is connected with the mounting cylinder. The first shaft is received in the mounting cylinder; the first driving mechanism is mounted on the installation wall for driving the first shaft to rotate, The second shaft is received in the mounting cylinder and rotatably sleeves on the first shaft. The second driving mechanism is mounted on the installation wall and spaced from the first driving mechanism for driving the second shaft to rotate.

### BACKGROUND

1. Technical Field

The present disclosure generally relates to robots, and particularly to a robot arm with several shafts.

2. Description of Related Art

Robot arms are rotatably connected in order. One or more materials are conveyed by the robot arms to one or more appointed positions. The robot arm includes a wrist body, a driver driving the robot arm to move, an arm body connected with the wrist body, a plurality of shafts received within the arm body and a plurality of driving mechanisms configured for driving the shafts. The driving mechanisms are usually positioned at an end of the arm body away from an operating end of the arm body.

Large-scale robots are needed to grasp or convey heavy materials or objects. The arm body of the large-scale robot is relatively long. Thus, it requires that the driving mechanisms are big and heavy. A load at the operating end including the weight of the driving mechanisms and of the materials together is much heavier than the load at the other end connected with the wrist body. Therefore, the balance of the robot arm is very one-sided. The robot arm of the large-scale robot is easily damaged and has low flexibility.

Therefore, there is room for improvement within the art.

### BRIEF DESCRIPTION OF THE DRAWINGS

The components in the drawings are not necessarily drawn to scale, the emphasis being placed upon clearly illustrating the principles of the present disclosure. Moreover, in the drawings, like reference numerals designate corresponding parts throughout several views, and all the views are schematic.

FIG. 1 shows an assembled isometric view of one embodiment of a robot arm.

FIG. 2 is a cross-section of the robot arm of FIG. 1, taken along a line labeled as II-II.

FIG. 3 is a partial isometric side view of the robot arm of FIG. 1.

### DETAILED DESCRIPTION

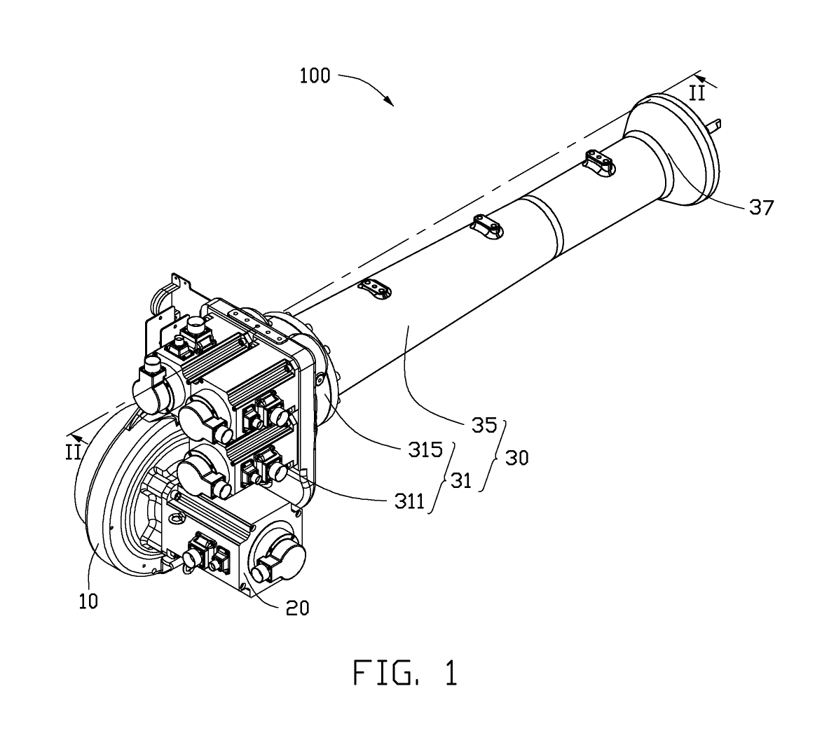

Referring to FIGS. 1 through 3, an embodiment of a robot arm 100 used in a large-scale robot (not shown), includes a wrist body 10, a driver 20, an arm body 30, a first shaft 40, a second shaft 50, a third shaft 60, a first driving mechanism 70 for driving the first shaft 40, a second driving mechanism 80 for driving the second shaft 50 and a third driving mechanism 90 for driving the third shaft 60. The driver 20 is positioned on the wrist body 10 to drive the robot arm 100 to move. The arm body 30 connects with the wrist body 10. The first shaft 40 is received in the arm body 30. The second shaft 50 rotatably sleeves on the first shaft 40 within the arm body 30. The third shaft 60 rotatably sleeves on the second shaft 50 within the arm body 30. The first, second and third driving mechanisms 70, 80, and 90 are positioned on one end of the arm body 30 connecting with the wrist body 10.

The wrist body 10 is substantially a circular disc structure, and rotatably connected with other robot arms (not shown).

The driver 20 is positioned on substantially a center of a side surface of the wrist body 10 for driving the robot arm 100 to move.

The arm body 30 perpendicularly extends from one edge of the wrist body 10, and extends away from the wrist body 10. The arm body 30 is substantially a hollow cylinder. The arm body 30 includes an installation wall 31 and a hollow mounting cylinder 35. The installation wall 31 perpendicularly extends from one edge of the wrist body 10 towards a side of the wrist body 10 where the driver 20 is positioned. The installation wall 31 includes an installation portion 311 and a receiving portion 315. The installation portion 311 is positioned on one side of the installation wall 31 away from the mounting cylinder 35. The receiving portion 315 is formed at one side of the installation wall 31 towards the mounting cylinder 35. The receiving portion 315 is used for receiving the first shaft 40, the second shaft 50, and the third shaft 60. The mounting cylinder 35 is connected with an end of the receiving portion 315 away from the installation portion 311.

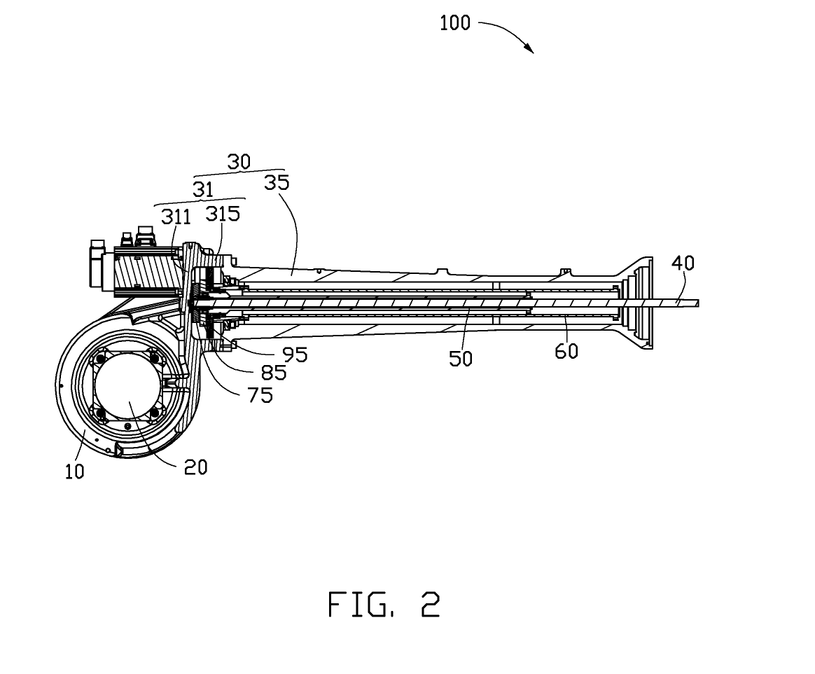

Referring to FIG. 2, the first shaft 40 is a solid object. The second and third shafts 50, 60 are a plurality of hollow structures. The first, second and third shafts 40, 50, 60 are received in the mounting cylinder 35 along the axis of the mounting cylinder 35. One end of the first, second and third shafts 40, 50, 60 extends into the receiving portion 315. The third shaft 60 rotatably sleeves on the second shaft 50, and the second shaft 50 rotatably sleeves on the first shaft 40. The arm body 30 further includes an operation end 37 positioned at one end of the arm body 30 away from the wrist body 10 for grasping or conveying heavy materials or objects (not shown).

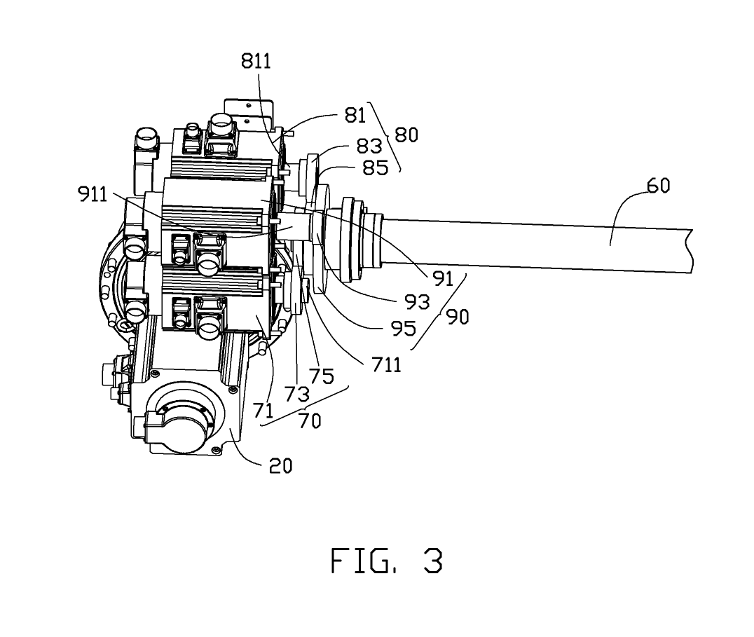

Referring to FIG. 3 again, the first driving mechanism 70 includes a first motor 71, a first driving gear 73, and a first transmission gear 75. The first motor 71 is positioned on the installation portion 311 above the driver 20 to drive the first driving gear 73. A first driving shaft 711 of the first motor 71 extends into the receiving portion 315. The first driving gear 73 sleeves on the first driving shaft 711 and non-rotatably connects with the first driving shaft 711. The first transmission gear 75 matching the first shaft 40 is received in the receiving portion 315. The first transmission gear 75 is non-rotatably connected with one end of the first shaft 40 extending in the receiving portion 315. The first transmission gear 75 and the first driving gear 73 are used for driving the first shaft 40 to rotate.

The second driving mechanism 80 includes a second motor 81, a second driving gear 83, and a second transmission gear 85. The second motor 81 is positioned on the installation portion 311 above the first motor 71 to drive the second driving gear. 83. A second driving shaft 811 of the second motor 81 extends into the receiving portion 315. The second driving gear 83 sleeves on the second driving shaft 811 and non-rotatably connects with the second driving shaft 811. The second transmission gear 85 matching the second shaft 50 is received in the receiving portion 315. The second transmission gear 85 is non-rotatably connected with one end of the second shaft 50 extending into the receiving portion 315. The second transmission gear 85 and the second driving gear 83 are used for driving the second shaft 50 to rotate.

The third driving mechanism 90 includes a third motor 91, a third driving gear 93, and a third transmission gear 95. The third motor 91 is positioned on the installation portion 311 above the first motor 71 and adjacent to the second motor 81 to drive the third driving gear 93. A third driving shaft 911 of the third motor 91 extends into the receiving portion 315. The third driving gear 93 sleeves on the third driving shaft 911 and non-rotatably connects with the third driving shaft 911. The third transmission gear 95 matching the third shaft 60 is received in the receiving portion 315. The third transmission gear 95 is non-rotatably connected with one end of the third shaft 60 extending into the receiving portion 315. The third transmission gear 95 and the third driving gear 93 are used for driving the third shaft 60 to rotate.

The first, second, and third motors 71, 81, 91 are positioned on the installation wall 31 to add the weight to the end of the arm body 30 connecting with the wrist body 10 and to reduce the weight of the operation end 37. That is, the end of the arm body 30 adjacent to the wrist body 10 carries the combined weight of the first, second, third driving mechanisms 70, 80, 90, and the operation end 37 of the arm body 30 carries the weight of only the external materials or objects that are to be carried. The balance, flexibility and stability of the arm body 30 are thereby much improved. A better distribution of weight also allows the robot arm 100 to move more quickly during work or usage.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A robot arm, comprising:
a wrist body;
an arm body comprising:
an installation wall extending from one edge of the wrist body; and
a hollow mounting cylinder connecting with the installation wall,
a first shaft received in the mounting cylinder;
a first driving mechanism mounted on the installation wall for driving the first shaft to rotate;
a second shaft received in the mounting cylinder and rotatably sleeving on the first shaft; and
a second driving mechanism mounted on the installation wall and spaced from the first driving mechanism for driving the second shaft.

2. The robot arm of claim 1, wherein the installation wall comprises an installation portion and a receiving portion, the installation portion is positioned on one side of the installation wall away from the mounting cylinder, the receiving portion is formed at one side of the installation wall towards the mounting cylinder; the first driving mechanism and the second driving mechanism are mounted on the installing portion and extend in the receiving portion.

3. The robot arm of claim 2, wherein the first driving mechanism comprises a first motor, the first motor comprises a first driving shaft, the first motor is positioned on the installation portion, the first driving shaft extend in the receiving portion.

4. The robot arm of claim 3, wherein the first driving mechanism further comprises a first driving gear and a first transmission gear, the first driving gear sleeves on the first driving shaft and non-rotatably connects with the first driving shaft, the first transmission gear is non-rotatably connected with one end of the first shaft extending in the receiving portion.

5. The robot arm of claim 2, wherein the second driving mechanism comprises a second motor, the second motor comprises a second driving shaft, the second motor is positioned on the installation portion and spaced from the first driving mechanism, the second driving shaft extend in the receiving portion.

6. The robot arm of claim 5, wherein the second driving mechanism further comprises a second driving gear and a second transmission gear, the second driving gear sleeves on the second driving shaft and non-rotatably connects with the second driving shaft, the second transmission gear is non-rotatably connected with one end of the second shaft extending in the receiving portion.

7. The robot arm of claim 1, wherein the robot arm further comprises a third shaft and a third driving mechanism mounted on the installation wall, the third driving mechanism drives the third shaft to rotate via at least two gears.

8. The robot arm of claim 7, wherein the third shaft rotatably sleeves on the second shaft

9. The robot arm of claim 7, wherein the third driving mechanism comprises a third motor, the third motor comprises a third driving shaft, the third motor is positioned on the installation portion and spaced from the first driving mechanism and the second driving mechanism, the third driving shaft extends into the receiving portion.

10. The robot arm of claim 9, wherein the third driving mechanism further comprises a third driving gear and a third transmission gear, the third driving gear sleeves on the third driving shaft and non-rotatably connects with the third driving shaft, the third transmission gear is non-rotatably connected with one end of the third shaft extending into the receiving portion.

11. The robot arm of claim 1, wherein the first shaft is solid.

12. The robot arm of claim 1, wherein the robot arm further comprises a driver, the driver is positioned on a middle portion of the wrist body for driving the robot arm to move.
